(19) United States
(12) Patent Application Publication
(10) Pub. No.: US 2011/0263751 A1
(43) Pub. Date: Oct. 27, 2011

(54) Highly Hydrophobic Coatings

(75) Inventors: Erwin-Peter Mayer, Burghausen (DE); Herbert Barthel, Mehring (DE); Arnulf Schindelar, Burghausen (DE)

(73) Assignee: Wacker Chemie AG, München (DE)

(21) Appl. No.: 13/132,788

(22) PCT Filed: Dec. 1, 2009
(86) PCT No.: PCT/EP2009/066134

§ 371 Date: Jun. 30, 2011

(30) Foreign Application Priority Data
Dec. 5, 2008 (DE) 10 2008 044 396.4

(51) Int. Cl. C09D 183/04; C08K 3/36; B32B 3/00; C09D 183/08

(52) U.S. Cl. 523/177; 524/588; 428/141

(57) ABSTRACT

The invention relates to a suspension comprising: fine-particulate particles in an amount of 0.01-50 wt %, wherein the particles have a fractal mass dimension Dₘ of less than or equal to 2.8, —fluid-elastic adhesive in an amount of 101-1000 parts by weight based on 100 parts of particles.

### CROSS REFERENCE TO RELATED APPLICATIONS

This application is the national phase filing of international patent application No. PCT/EP2009/066134, filed 1 Dec. 2009, and claims priority of German patent application number 10 2008 044 396.4, filed 5 Dec. 2008, the entireties of which applications are incorporated herein by reference.

### FIELD OF THE INVENTION

The invention relates to suspensions and to coatings.

### BACKGROUND OF THE INVENTION

There are particle dispersions, metal oxide dispersions, and silica dispersions in water known which are electrostatically stabilized anionically through addition of alkalinity or of anionic polyelectrolytes. Another known form is that of cationic stabilization, through addition of acid or of cationic polyelectrolytes.

Where particle dispersions or silica dispersions, in the form of a molding or a coating, are dried, the structures produced are not mechanically stable; the resultant particle or silica cakes or bodies crumble or disintegrate under mechanical load.

### SUMMARY OF THE INVENTION

It is an object of the invention to improve the state of the art and in particular to produce moldings or coatings from particle dispersions or silica dispersions, by drying, that acquire mechanically stable structures; in other words, the resultant particle or silica cakes or bodies do not crumble or disintegrate under mechanical load.

The object is achieved by means of the invention.

### DETAILED DESCRIPTION OF THE INVENTION

The invention provides a suspension comprising
finely divided particles in amounts of 0.01%-50% by weight, the particles having a fractal mass dimension Dₘ of less than or equal to 2.8,
liquid
elastic adhesive in amounts of 101-1000 parts by weight per 100 parts of particles.

Preferred suspensions of the invention are as follows:

Suspensions of the invention comprising
finely divided particles 0.01%-50%, preferably 1-30%, more preferably 2-15%, by weight, based on the total weight of the suspension,
liquid
elastic adhesive such as preferably reactive oligomer or polymer or crosslinking system in amounts of preferably 101-1000 parts by weight, preferably 101-500 parts, more preferably 101-400 parts, very preferably 101-300 parts, per 100 parts of particles.

### Liquids:

Liquids of the invention are preferably those having a viscosity in pure form of less than 100 mPas at 25° C., more preferably less than 10 mPas, very preferably less than 2 mPas.

Examples are preferably water, protic solvents such as alcohols, such as methanol, ethanol or isopropanol, and nonprotic polar solvents, such as ketones such as acetone, methyl ethyl ketone, methyl isobutyl ketone, ethers such as tetrahydrofuran, dioxanes, amides such as dimethylformamide, and nonpolar solvents, such as alkanes, such as cyclohexane, decanes, benzines, such as light benzine, cleaning benzine, or low-boiling and higher-boiling hydrocarbons, such as aromatic hydrocarbons, such as benzene, toluene, xylene. Preference is given to liquids having a boiling point below 150° C., more preferably having a boiling point below 120° C.

Preference is given to liquids having an enthalpy of vaporization of less than 55 kJ/mol, more preferably having a vaporization enthalpy of less than 45 kJ/mol. Particularly preferred examples are protic and polar organic solvents, among which preference is given to methanol, ethanol, isopropanol, tetrahydrofuran, dioxane, acetone, methyl ethyl ketone, methyl isobutyl ketone, hydrocarbons, and mixtures thereof.

In an especially preferred form, water is advantageous.

### Particles:

Preference is given to particles having preferably an average diameter of less than 100 μm.

The particles used in accordance with the invention preferably have an average diameter of more than 10 nm, more preferably of 10 nm to 100 μm, very preferably of 50 nm to 10 μm, especially preferably of 100 nm to 1000 nm, very preferably also from 100 nm to 350 nm. Besides pure particle sizes, any desired mixing ratios of any desired sizes may also be used.

The particles of the invention are preferably particles which are solid at room temperature under the pressure of the surrounding atmosphere, in other words at between 900 and 1100 hPa.

The particles are preferably insoluble or of low solubility in water or in other solvents which may be used for preparing the suspension of the invention.

The particles used in accordance with the invention preferably have a molar mass of more than 10 000 g/mol, more preferably a molar mass of 50 000 to 100 000 000 g/mol, more particularly from 100 000 to 10 000 000 g/mol, in each case measured preferably by means of static light scattering.

The particles used in accordance with the invention preferably have a specific BET surface area of 1 to 500 m²/g, more preferably 20 to 300 m²/g. The BET surface area is measured by known methods, preferably in accordance with German Industry Standard DIN 66131 and DIN 66132.

The particles used in accordance with the invention preferably have a carbon content of less than 50 percent by weight.

The particles preferably have a Mohs hardness of greater than or equal to 1. With particular preference the particles used in accordance with the invention have a Mohs hardness of greater than 4.

Particles may be composed of preferably organic resins, such as silicone resins, e.g., methylsilicone resins, such as epoxy resins, such as acrylic resins, e.g., polymethyl methacrylates; and also polymers, such as polyolefins, e.g., polystyrene; and also metal colloids, e.g., silver colloids; and also metal oxides, e.g., oxides from main group II, such as magnesium oxide, e.g., oxides from main group III, such as aluminum oxides, from main group IV, such as silicon dioxide, germanium oxide, and main group V, and, for example, oxides of the transition group metals, such as titanium(IV) dioxides, such as zirconium(IV) oxides, such as hafnium(IV) oxides, such as zinc oxides, such as iron oxides, such as iron(II) oxides and iron(III) oxides, such as manganese oxides; and, for example, oxides of the lanthanides, such as cerium(IV) oxides; and also any desired mixtures of these oxides, such as mixed silicon dioxide-aluminum oxide oxides with any desired composition, preferably with a silicon dioxide content of 20% to 100% by weight, such as mixed silicon dioxide-iron oxide oxides with any desired composition, preferably with a silicon dioxide content of 20% to 100% by weight, such as mixed silicon dioxide-titanium(IV) oxide oxides with any desired composition, preferably with a silicon dioxide content of 20% to 100% by weight; and also insoluble or sparingly soluble ionic and mineral compounds, e.g., calcium carbonates, barium sulfates, iron(II) sulfides, such as pyrites, magnesium silicates, calcium silicates, aluminum silicates, such as aluminum phyllosilicates, e.g., clays, such as bentonites, montmorillonites, and hectorites, which may also have been organically modified; and also micronized minerals and finely ground rocks; and also sparingly soluble nonionic compounds, such as boron nitrides, silicon nitrides or silicon carbides, are selected.

Preferred metal oxides are those having specific BET surface areas of greater than 10 m²/g, such as metal oxides produced in high-temperature processes, such as fumed metal oxides produced in flame processes, such as metal oxides produced in plasma processes, such as metal oxides produced in hot-wall reactors, and metal oxides produced by laser methods. Preference is given to metal oxides in fractal aggregate structure, having a fractal mass dimension of less than 2.8. Preferred silicas are those having specific BET surface areas of greater than 10 m²/g, more preferably synthetic silicas, such as, for example, wet-chemically produced silicas, such as silica sols and silica gels, such as fumed silicas produced in flame processes, such as silicon dioxides produced in plasma processes, such as silicon dioxides produced in hot-wall reactors, such as silicon dioxides produced in laser processes, more preferably fumed silica produced at preferred temperatures of above 1000° C.

The particles of fumed silica preferably have a solubility in water at a pH of 7.6 with an electrolyte background of 0.11 mol/l and at a temperature of 25° C. of less than 0.3 g/l, more preferably of less than 0.15 g/l, under the pressure of the surrounding atmosphere, in other words of between 900 and 1100 hPa.

The particles of fumed silica preferably have an average primary particle size d-PP of 0.5 to 1000 nm, more preferably 5 to 100 nm, very preferably 10 to 75 nm. Suitable measurement methods for this purpose are, for example, the determination of the BET surface areas and of the density of the material: d-PP=6/(BET*material density); for example, transmission electron microscopy or high-resolution scanning electron microscopy, e.g., in field emission mode, as for example ultrasound spectroscopy in the measurement range of 1 to 100 MHz.

The particles of fumed silica preferably have an average secondary-structure or aggregate particle size d-aggr of 50 to 5000 nm, more preferably 50 to 500 nm, measured as the hydrodynamic equivalent diameter.

Suitable measurement methods for this purpose are, for example, dynamic light scattering or photon correlation spectroscopy, for the measurement of concentrations greater than 0.01% by weight of solid, it being possible for this measurement to be performed as backscattering and/or to be corrected by means of cross-correlation against multiple scattering.

The particles of fumed silica preferably have an average tertiary or agglomerate particle size d-aggl of greater than 100 nm, measured as the geometric diameter.

Suitable measurement methods for this purpose are, for example, laser light diffraction, as for example Fraunhofer light diffraction.

The particles of fumed silica preferably have a specific surface area of 1 to 1000 m²/g, more preferably 10 to 500 m²/g, very preferably of 30 to 300 m²/g (measured by the BET method in accordance with DIN 66131 and 66132).

The particles of fumed silica preferably have a fractal surface dimension Dₛ of preferably less than or equal to 2.3, more preferably of less than or equal to 2.1, very preferably of 1.95 to 2.05, the fractal surface dimension Dₛ here being defined as:

Particle surface area is proportional to the particle radius R to the power of Dₛ.

The particles of fumed silica preferably have a fractal mass dimension Dₘ of preferably less than or equal to 2.8, more preferably of less than or equal to 2.5, very preferably of 1.9 to 2.2. The fractal mass dimension Dₘ here is defined as:

Particle mass is proportional to the particle radius R to the power of Dₘ.

It is also possible to use preferably hydrophilic silicas which are freshly produced and come, for example, directly from the flame; those which have been stored in the interim; or those which have already undergone commercially customary packaging. It is also possible to use hydrophobized or silylated silicas, e.g., commercial silicas.

It is possible to use preferably uncompacted silicas, with bulk densities of less than 60 g/l, but also compacted silicas, having bulk densities of greater than 60 g/l.

It is possible with preference to use mixtures of different silicas, as for example mixtures of silicas with different BET surface areas, or mixtures of silicas with different degrees of hydrophobization or of silylation.

In a further embodiment, the particles are hydrophobic particles, more preferably surface-modified metal oxides, the surface-modified metal oxides being preferably silylated metal oxides modified with organosilicon compounds, and very preferably silylated fumed silica.

The silylation (hydrophobization) of silicas is described in DE 102004063762.

Preferred hydrophobic and highly hydrophobic particles are those having a fractal mass dimension (Dm) of Dm less than 3, more particularly Dm less than 2.5, very preferably Dm less than 2.2, outstandingly Dm less than 2.1.

Preferred hydrophobic and highly hydrophobic particles are those having tamped densities in accordance with DIN EN ISO 787-11 of tamped densities less than 500, in particular less than 250 g/l, more particularly less than 120 g/l, very particularly less than 60 g/l.

Preference is given to hydrophobic and highly hydrophobic particles which consist of agglomerates with a size of 0.5 to 100 μm, which are composed in turn of aggregates with a size of 50 to 500 nm, and with hydrodynamic diameters in water of 100 to 250 nm.

Further preferred are finely divided particles which have reactive surface groups, such as, for example, above-described particles which are modified with silylating agent in order to obtain the reactive surface groups.

Besides hydrophilic particles, hydrophobic and highly hydrophobic particles as well may be employed.

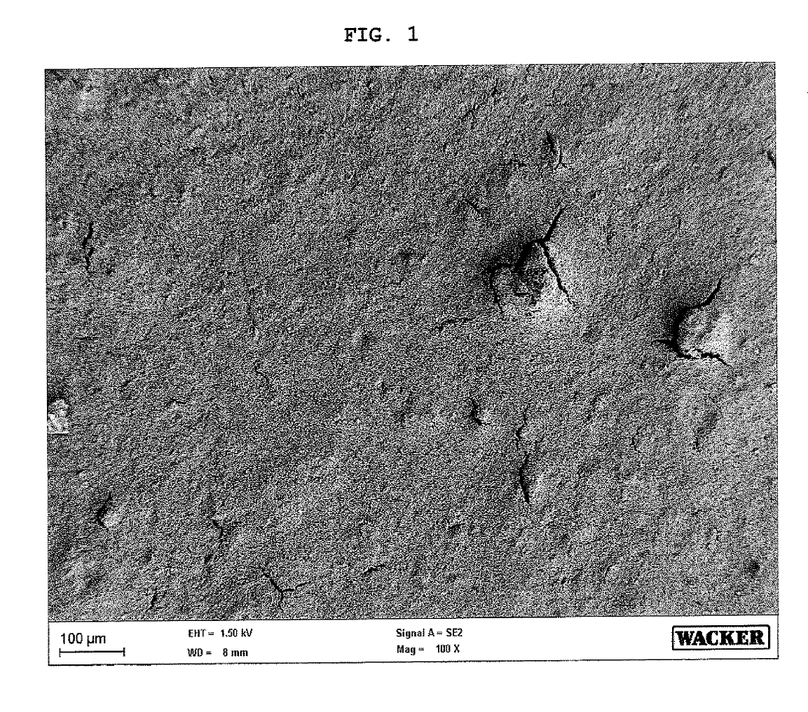

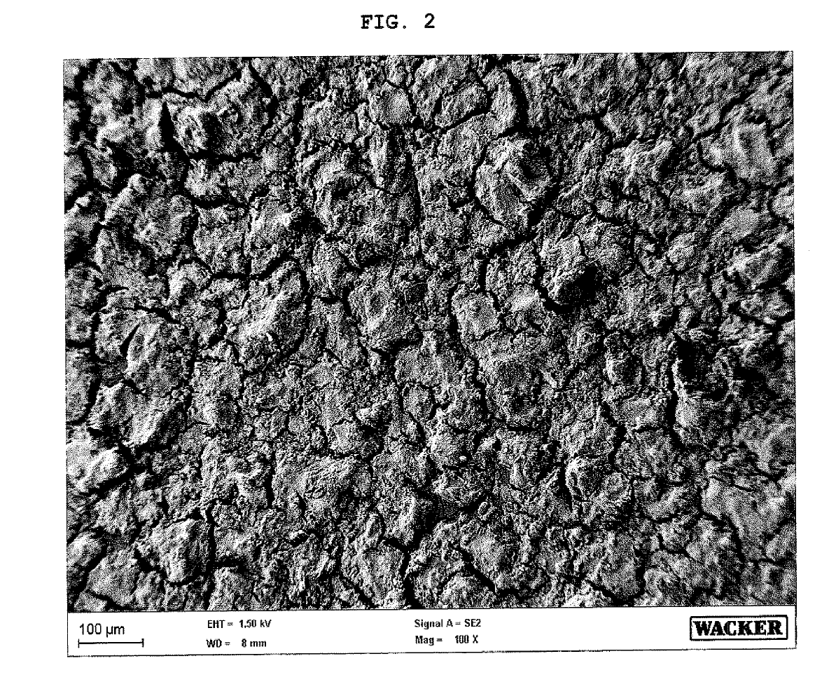

Particular preference is given to the use of hydrophilic particles, since these particles, as is evident from FIG. 1, exhibit far fewer cracks in a completed coating than if hydrophobic particles are used—see FIG. 2.

The particles are used in the suspension in proportions of preferably 0.01%-50%, more preferably 5%-40%, and very preferably 10%-30% by weight.

The particles are used in the coating in proportions of preferably 0.01%-50%, more preferably 5%-45%, and very preferably 20%-30% by weight.

### Elastic Adhesive

Elastic adhesive bonds the particles elastically, and is added preferably in the amounts as described above.

The elastic adhesive may be the same as or different from the particles.

The material of the elastic adhesive is preferably different in its physical composition from the material of the particles. Preferably more than 5%, more preferably more than 50%, by weight, based on the total weight of elastic adhesive and particles.

Preferred embodiments for elastic adhesive:

### a) Reactive Oligomer or Polymer:

All polymers, prepolymers, reactive precursors, polymers which can be employed as binders, which are able to react or crosslink with themselves or with the particles.

Component (A) may comprise all monomeric, oligomeric, and polymeric compounds which it has also been possible to disperse to date, and these compounds may be linear, branched or cyclic. Component (A) may preferably comprise reactive compounds which, following removal of the water, can be converted into elastomers and/or resins, or nonreactive compounds which, following removal of the water, are present unchanged.

Examples of component (A) are preferably organosilicon compounds, such as organo(poly)silanes, organo(poly)-siloxanes, organo(poly)silazanes, and organo(poly)sil-carbanes; polyolefins, such as silyl-terminated polyisobutylenes (e.g., available under the brand name Epion from Kaneka Corp., Japan); polyurethanes, polyols, such as hydroxy-containing polyesters, hydroxy-containing polyethers, methyldimethoxy-silylpropyl-terminated polypropylene glycols (e.g., available as “MS-Polymere” from Kaneka Corp., Japan), hydroxy-containing polyacrylates; polyisocyanates, such as aliphatic and aromatic polyisocyanates, isocyanate-terminated polyurethane prepolymers, prepared by reacting polyols with polyisocyanates in excess, and also their silyl-terminated derivatives (e.g., available under the name DESMOSEAL® from Bayer AG, Germany); (poly)epoxy compounds, such as bisphenol A-based epoxides, monomeric, oligomeric, and polymeric compounds containing glycidyloxy functions, such as diglycidyl ethers based on bisphenol A, epoxy-novolac base materials and resins, epoxy alkyd resins, epoxyacrylates, aliphatic epoxides such as linear alkylene bisglycidyl ethers and cycloaliphatic glycidyl ethers, such as 3,4-epoxycyclohexyl 3,4-epoxycyclo-hexanecarboxylates, and aromatic epoxides, such as triglycidyl ethers of p-aminophenol and triglycidyl ethers of methylenedianiline; (poly)amines, such as cyclic and linear amines, such as hexamethylenediamine, aromatic amines, such as 4,4′-methylenebis(2,6-diethylaniline), bis(2-aminoalkyl)polyalkylene oxide, such as bis(2-aminopropyl)polypropylene glycol and Jeffamines, (poly)amidoamines, (poly) mercaptans, (poly) carboxylic acid, (poly) carboxylic anhydrides; acrylates and their esters, such as glycidyl acrylates, alkyl acrylates and their esters, methacrylates and their esters, polysulfide-forming polymers and polysulfides, such as thioplastics (e.g., available under the brand name Thiokol from Toray Thiokol Co. Ltd.).

Examples of epoxy compounds are preferably alkylene bisglycidyl ethers, such as

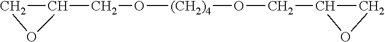

bisphenol A-based diglycidyl ethers, such as

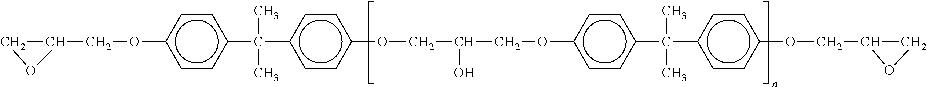

with n preferably from 0 to 10, more preferably 0 to 5.

Examples of epoxy-novolac resins are those of the formula

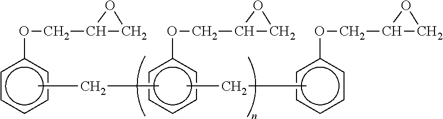

bifunctional epoxy compounds, such as

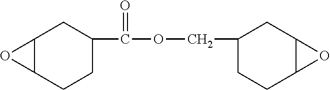

trifunctional epoxy compounds, such as

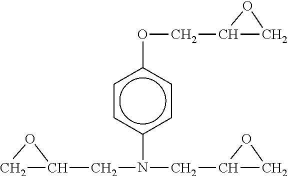

tetrafunctional epoxy compounds, such as

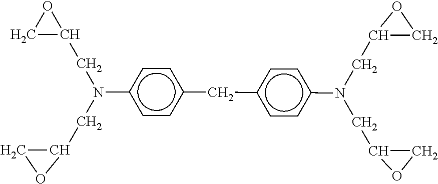

The component (A) used for preparing the dispersions of the invention is liquid or solid at room temperature under the pressure of the surrounding atmosphere, in other words at between 900 and 1100 hPa.

If the component (A) used in accordance with the invention is liquid, it has a viscosity of preferably 1 to 10 000 000 mm²/s, more preferably from 100 to 500 000 mm²/s, more particularly preferably from 1000 to 350 000 mm²/s, in each case at 25° C.

Component (A) preferably comprises organosilicon compounds, more preferably those comprising units of the formula

Rₐ(OR¹)_{b}X_{c}SiO_{(4-a-b-c)/2} (I),

where

R denotes identical or different SiC-bonded hydrocarbon radicals having 1 to 18 carbon atoms, which are optionally substituted by halogen atoms, amino groups, ether groups, ester groups, epoxy groups, mercapto groups, cyano groups or (poly)glycol radicals, the latter being composed of oxyethylene and/or oxypropylene units,

R¹ may be identical or different and denotes hydrogen atom or optionally substituted hydrocarbon radical, which may be interrupted by oxygen atoms,

X may be identical or different and denotes halogen atom, pseudohalogen radical, Si—N-bonded amine radicals, amide radicals, oxime radicals, amineoxy radicals, and acyloxy radicals,

a is 0, 1, 2 or 3, preferably 1 or 2,

b is 0, 1, 2 or 3, preferably 0, 1 or 2, and

c is 0, 1, 2 or 3, preferably 0 or 1, more preferably 0,

with the proviso that the sum of a+b+c is less than or equal to 4.

The organosilicon compounds used as component (A) in accordance with the invention may comprise not only silanes, i.e., compounds of the formula (I) with a+b+c=4, but also siloxanes, i.e., compounds comprising units of the formula (I) with a+b+c≦3. The organosilicon compounds used in accordance with the invention, comprising units of the formula (I), are preferably organopolysiloxanes, more particularly those composed of units of the formula (I).

Examples of hydrocarbon radicals R are preferably alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl, naphthyl, anthryl, and phenanthryl radical; alkaryl radicals, such as o-, m-, p-tolyl radicals, xylyl radicals, and ethylphenyl radicals; aralkyl radicals, such as the benzyl radical, the alpha- and the beta-phenylethyl radical.

Examples of substituted hydrocarbon radicals R are preferably halogenated radicals such as the 3-chloropropyl radical, the 3,3,3-trifluoropropyl radical, chlorophenyl radicals, hexafluoropropyl radicals, such as the 1-trifluoromethyl-2,2,2-trifluoroethyl radical; the 2-(perfluorohexyl)ethyl radical, the 1,1,2,2-tetrafluoroethyloxypropyl radical, the 1-trifluoromethyl-2,2,2-trifluoroethyloxypropyl radical, the perfluoroisopropyloxyethyl radical, the perfluoroisopropyloxypropyl radical; radicals substituted by amino groups, such as the N-(2-aminoethyl)-3-aminopropyl radical, the 3-aminopropyl radical, the 3-(cyclohexylamino)propyl radical, the aminomethyl radical, the cyclohexylaminomethyl radical, and the diethylaminomethyl radical; ether-functional radicals, such as the 3-methoxypropyl radical, the methoxymethyl radical, the 3-ethoxypropyl radical, and the acetoxymethyl radical; cyano-functional radicals, such as the 2-cyanoethyl radical; ester-functional radicals, such as the methacryloyloxypropyl radical; epoxy-functional radicals, such as the glycidyl-oxypropyl radical, and sulfur-functional radicals, such as the 3-mercaptopropyl radical.

Preferred radicals R are hydrocarbon radicals having 1 to 10 carbon atoms, with more preferably at least 80%, more particularly at least 90%, of the radicals R being methyl radicals.

Examples of radicals R¹ are the examples specified for radical R.

Preferred radicals R¹ are hydrogen atom and alkyl groups having 1 to 6 carbon atoms, more preferably hydrogen atom and methyl and ethyl radicals, more particularly hydrogen atom.

Examples of X are preferably halogen atoms, such as chlorine atoms, bromine atoms, pseudohalides, such as —CN, —NCO, and —OCN, amine radicals such as diethylamino and cyclohexylamino radical, amide radicals such as N-methylacetamido and benzamido radical, amineoxy radicals such as diethylamineoxy radical, and acyloxy radicals such as the acetoxy radical, with chlorine atoms being preferred.

Component (A) preferably comprises commercial substances and/or can be prepared by methods that are common in organic or organosilicon chemistry.

Examples are also preferably polymers or oligomers which are able to enter into zwitterions or ion pairs or ionic bonds with themselves or with the particles. Examples of such are, for the case that (A) strongly or weakly acidic groups are attached to the particle, such as —COOH or acidic —OH, such as M-OH, such as BOH, SiOH, GeOH, ZrOH groups, then preferably polymers having basic groups, such as polymers which carry amino groups, such as primary, secondary or tertiary amines, e.g., aminosiloxanes, such as linear and branched aminosiloxanes, such as liquid and solid aminosiloxanes, such as aminosiloxane polymers or aminosiloxane resins, as for example polydimethylsiloxanes having gamma-amino-propyl or alpha-amino-methyl groups which are terminal or bonded to an Si atom in the chain, having a viscosity at 25° C. of 500-5000 mPas and an amine number of 0.5 to 10. Preference is given to the combination of particles with SiOH groups and aminopolysiloxane, more preferably fumed silica and aminopolysiloxanes or amino-dimethylpolysiloxanes.

Further preferred examples are silane-terminated polymers. Examples thereof are silane-terminated polyisocyanates, polyols, such as polyacrylate polyols, polyester polyols or polyether polyols, of the kind used for preparing polyurethanes. The silane termination of polyacrylate polyols may be accomplished preferably by copolymerization with methacryloyloxy-functional alkoxysilanes, such as methacryloyloxy-propyltrimethoxysilane or, preferably, with meth-acryloyloxymethyltrimethoxysilane.

The silane termination of polyisocyanates may be accomplished preferably by reaction with amino-functional alkoxysilanes, such as aminopropyl-trimethoxysilane or, preferably, with aminomethyl-trimethoxysilane.

The adhesive is used in the suspension in proportions of preferably 0.01%-50%, more preferably 5%-40%, and very preferably 20%-50%, by weight, based on the overall suspension.

The adhesive is used in the coating preferably in proportions of 50%-95%, more preferably 55%-85%, and very preferably 60%-80%, by weight, based on the overall suspension.

### b) Crosslinking Systems

Resin and curing-agent systems, of the kind used for producing resins and elastomers, such as for epoxy resins and epoxy elastomers, polyurethane resins and polyurethane elastomers, acrylates, polyolefins, polycarbonates, polysulfones, polysulfides, polyamides, and also for silicone resins and rubbers. Preference is given to silicone elastomers; particularly preferred are RTV silicone elastomers, especially preferred are RTV-2 silicone elastomers, which are condensation- or addition-crosslinking, or RTV1 silicone elastomers which are addition-crosslinking or radically peroxidically crosslinking; especially preferred are moisture-curing, amine-crosslinking RTV1 silicone elastomers.

A variant are crosslinking systems from the area of coating materials, such as, for example: fatty oils, short-, medium-, and long-oil alkyd resins, stand oils, and combinations thereof, and also modified alkyd resins, such as styrene-modified alkyd resins, acrylic ester-modified alkyd resins, silicone-modified alkyd resins, urethane-modified alkyd resins, epoxy resin-modified alkyd resins, oxidatively drying film-forming binders, such as short-, medium-, and long-oil alkyd resins, stand oils, and combinations thereof, polyesters.

Chemically or reactively drying film-forming binders, such as polyurethanes, such as 1-component and 2-component polyurethanes, such as epoxy resin system, such as 2-component systems, epoxides which are crosslinked with amines, and those which are crosslinked with isocyanates.

Addition polymers, such as poly(meth)acrylates, polyvinyl esters, polyvinyl alcohols, polyvinylacetals, polyvinyl chlorides, polyfluorinated polyethylenes, with monomeric starting components such as methyl methacrylate, butyl acrylate, ethylhexyl acrylate, hydroxyethyl acrylate, hydroxyethyl methacrylate, hydroxypropyl methacrylate, acrylic acid, styrene.

Polycondensation resins, such as oil-free saturated polyesters, oil-modified polyester resins. Unsaturated polyester resins, from polyfunctional carboxylic acids and their anhydrides, monofunctional carboxylic acids, polyfunctional alcohols, such as phthalic anhydride, isophthalic acid, terephthalic acid, hexahydrophthalic anhydride, tetrahydroxophthalic anhydride, hexahydroxoterephthalic acid, adipic acid, maleic acid, fumaric acid, azelaic acid, sebacic acid, decanedicarboxylic acid, dimerized fatty acids, trimellitic anhydride, pyromellitic anhydride, 1,4-cyclohexanedicarboxylic acid, dimethylolpropionic acid, and polyols, such as ethylene glycol, 1,2-propanediol, 1,5-pentanediol, diethylene glycol, 1,4-butanediol, 1,6-hexanediol, neopentylglycol, trimethylpentanediol, 1,4-cyclohexanedimethanol, tricyclodecanedimethanol, trimethylolpropane, glycerol, pentaerythritol, hydrogenated bisphenol A, bisphenol A bis-hydroxyethyl ether, and modifications with monomers of the type, acrylic monomers, alkoxysilanes, alkoxypolysiloxanes, and amino-formaldehyde resins, such as urea formaldehyde resins, melamine-formaldehyde resins, and benzoguanamine resins, and also from amino compounds such as aromatic amines, carboxamides, cyanamides, guanamines, guandiamines, ureas, sulfonamines, sulfurylamides, thioureas, triazines (melamine resins), urethanes, and carbonyl compounds such as acetaldehyde, acetone, butyraldehyde, formaldehyde, glyoxal, propionaldehyde, trichloroacetaldehyde, and also phenol-formaldehyde resins and silicone resins.

### Polyaddition Resins

Polyurethanes, such as, for example, 2-component polyurethanes, 1-component polyurethane systems, 1-component moisture-curing polyurethane prepolymers, from polyisocyanates from base products, such as aromatic diisocyanates, aliphatic diisocyanates, cycloaliphatic diisocyanates, tolylene diisocyanate (TDI) isomer mixture, diphenylmethane diisocyanate (MDI) isomer mixture, hexamethylene diisocyanate (HDI), isophorone diisocyanate (IPDI), 4,4′-(isocyanatocyclohexyl)methane (H12MDI) isomer mixture, xylylene diisocyanate (XDI) isomer mixture, hydrogenated xylylene diisocyanate (HXDI) isomer mixture, trimethylhexane diisocyanate (TMDI) isomer mixture, blocked polyisocyanates, based on typical blocking agents such as malonic esters/acetoacetic esters, secondary amines, butanone oxime, phenols, caprolactam, alcohols, epoxy resins, liquid, semisolid, solid bisphenol A and F epoxy resins, and also phenol novolac glycidyl ethers, cresol novolac glycidyl ethers, cycloaliphatic glycidyl compounds and epoxidized cycloolefins, curing agents based on aliphatic amines, polyfunctional amines based on polyetherpolyamines, -propylenediamines, alkylenediamines, cycloaliphatic amines, polyaminoamides, Mannich bases, epoxide adducts, mercaptans, acid anhydrides.
Silicone resins, such as, for example, methylsilicone resins, phenylsilicone resins. Preference is given to primary, secondary, and tertiary amino-functional silicone resins having an amine number of 0.5 to 10 and a molecular weight of 250-20 000 mol/g.

1-component moisture-curing RTV silicone sealants and adhesive systems, preferably those which are filler-free.

Examples of suitable polymers are OH-terminal polydimethylsiloxanes having a viscosity of 20 to 200 000 mPas, preferably 1000-100 000 mPas.

As crosslinkers it is possible to use known crosslinkers which are used in commercial 1-component moisture-curing RTV silicone sealants and adhesive systems, such as, for example, tri- and tetra-alkoxysilanes, such as tri- and tetra-methoxy- and -ethoxysilanes, tri- and tetra-acetoxysilanes, tri- and tetra-oximosilanes, and tris- and tetrakis N-alkyl-amino-silamines. Preference is given to tris- and tetrakis N-alkyl-amino-silamines which lead to crosslinking without further catalyst or metal compound addition.

Preferred examples of silamines are tris(N-(n-butylamino))methylsilane, tris(N-(tert-butylamino))-methylsilane; especially preferred are tris(N-(isopropylamino))methylsilane and tris(cyclohexyl-amino)methylsilane.
2-component condensation-curing RTV silicone composition, preferably filler-free.
2-component Pt- and addition-crosslinking-curing LSR RTV silicone sealant and adhesive systems, preferably filler-free.

### Preparation:

The preparation (A) of the hydrophilic starting silica is accomplished preferably by known technology of the preparation of fumed silica at high temperature through the reaction of a silane in a hydrogen-oxygen flame at temperatures of 1000-1500° C. As silane it is preferred to use tetrachlorosilane, methyltrichlorosilane, hydrogentrichlorosilane, hydrogenmethyldichlorosilane, tetramethoxysilane, tetraethoxysilane, hexamethyl-disiloxane, or mixtures thereof. Tetrachlorosilane is particularly preferred. After the reaction, the silica is separated from process gas. This is accomplished preferably via a filter, and is followed by purification to remove the remaining hydrogen chloride gas. This is accomplished preferably in a hot gas stream, with gases used being preferably air or nitrogen at temperatures of preferably 250° C.-500° C., more preferably 250° C.-400° C., and very preferably 350° C.-400° C. In any case, not more than 10% by weight of water, based on the total weight of the silica, is added here; preferably not more than 5% by weight, more preferably not more than 2.5% by weight, and more preferably no water at all is added.

The surface treatment or silylation (B) of the silica takes place in 3 steps, namely (1) coating, (2) reaction, (3) purification.

For preparing the suspensions of the invention, the particle types may be added to the liquid and are distributed by wetting, or by shaking, such as with a tumble mixer, or a high speed mixer, or by stirring. With low particle concentrations, simple stirring is generally sufficient for incorporating the particles into the liquid. It is preferred, especially at high particle concentrations, to undertake the incorporation and dispersing of the particles into the liquid at a very high shear rate. Dispersing may be done in customary mixing devices suitable for producing emulsions or dispersions, which deliver a sufficiently high input of shearing energy, such as, for example, high-speed stator-rotor stirring devices, such as those according to Prof. P. Willems, for example, known under the registered trade mark “Ultra-Turrax”, or other stator-rotor systems, known under the registered trade mark such as Kady, Unimix, Koruma, Cavitron, Sonotron, Netzsch or Ystral. Other methods are ball mills, such as Dyno-Mill from WAB, CH, for example. Further methods are high-speed stirrers, such as paddle stirrers or crossarm stirrers, dissolvers, with peripheral speeds of 1-50 m/s, for example, such as disk dissolvers from the company Getzmann, for example, or mixing systems such as planetary dissolvers, crossarm dissolvers or other combined assemblies comprising dissolver systems and stirrer systems. Other suitable systems are extruders or compounders.

This may take place in batch processes and in continuous processes.

Particularly suitable are systems which to start with, with effective stirring elements, bring about the wetting and incorporation of the silica into the liquid, e.g., in a closed container or boiler, and in a second step disperse the silica at very high shear rate. This may be effected by a dispersing system in the first container, or by pumped circulation in an external pipeline which contains a dispersing element, from the container with preferably closed recycling into the container. Through partial recycling, and partial continuous removal, this process may preferably be designed continuously.

Especially suitable for the dispersing of the silica in the dispersion of the invention is the use of ultrasound in the range from 5 Hz to 500 kHz, preferably 10 kHz to 100 kHz, very preferably 15 kHz to 50 kHz; the ultrasonic dispersing may take place continuously or batchwise. This may be effected by individual ultrasonic input devices, such as ultrasound tips, or in continuous-flow systems which contain one or more ultrasonic input devices, such as ultrasound methods such as ultrasound fingers and input devices or continuous-flow ultrasound cells, or ultrasound systems such as or analogous to those offered by Sonorex/Bandelin.

Ultrasonic dispersing may take place continuously or batchwise.

The process of the invention for dispersing particles in a liquid may be carried out both batchwise and continuously.

The dispersion of the invention can of course also be prepared in another way. It has emerged, however, that the procedure is critical and that not all modes of preparation produce dispersions.

The methods of the invention have the advantage that they are very easy to carry out, and aqueous suspensions with very high solids contents can be prepared.

### Method of Determining the Contact Angle

In the measurement of the static contact angle, the method of the sessile drop is employed. The surface of the solid for measurement ought to be largely planar. One drop of water with a volume of 3.5 μl is applied by means of a syringe to the solid or to the coating. Since the contact angle is time-dependent, the drop is photographed immediately after application. A digital image analysis is performed on the photographed drop.

The static contact angle is the internal angle between the tangent of the drop of liquid and the solid or surface.

### Method of Determining the Water Drop Run-Off Test:

In the water drop run-off test, a specimen with the coating is provided, using a dropping pipette, with a water drop of approximately 0.01 ml, and the specimen is then slowly inclined from the horizontal position of the coated surface. The angle at which the water drop begins to run off from the coating is termed the run-off angle.

### Use of the Suspensions of the Invention

Production of moldings and layers.
Use of layers.
For protection against soiling, e.g., as an antigraffiti coating, or as a soil-release coating on buildings and constructions.
As a coating on surfaces in contact with seawater or inland waters, characterized in that the coating comprises an inventively nanostructured coating, having a roughness in dimensions of less than one micrometer. Examples of coated surfaces are ships, hulls, boats, yachts, drilling platforms, moorings, cables, nets, as for example for aquaculture, and weirs.
As a coating on ships, with nanostructured coatings, for preventing population by bacteria, algae, plants, fungi, and animals, such as barnacles, mussels, and others, with the advantage of a longer useful life of, for example, nets for fish farms and crustation farms, in marine and fluvial and inland waters, and for reducing the frictional resistance of ships, with the advantage of a higher speed and/or low energy consumption, e.g., lower fuel consumption, and hence preservation of natural resources, and lower costs.
Surprisingly, the coating of the invention produces a superhydrophobic surface which regenerates itself by erosion and ablation.
As a coating for surfaces in contact with seawater or inland waters, such as surfaces of ships and hulls, boats, yachts, marine constructions, such as weirs or moorings in the sea and in inland waters and coastal waters, nets for aquaculture of fishes and crustations, in seawater and in inland waters, for example, for preventing algal infestation and infestation with sessile animals, such as barnacles.

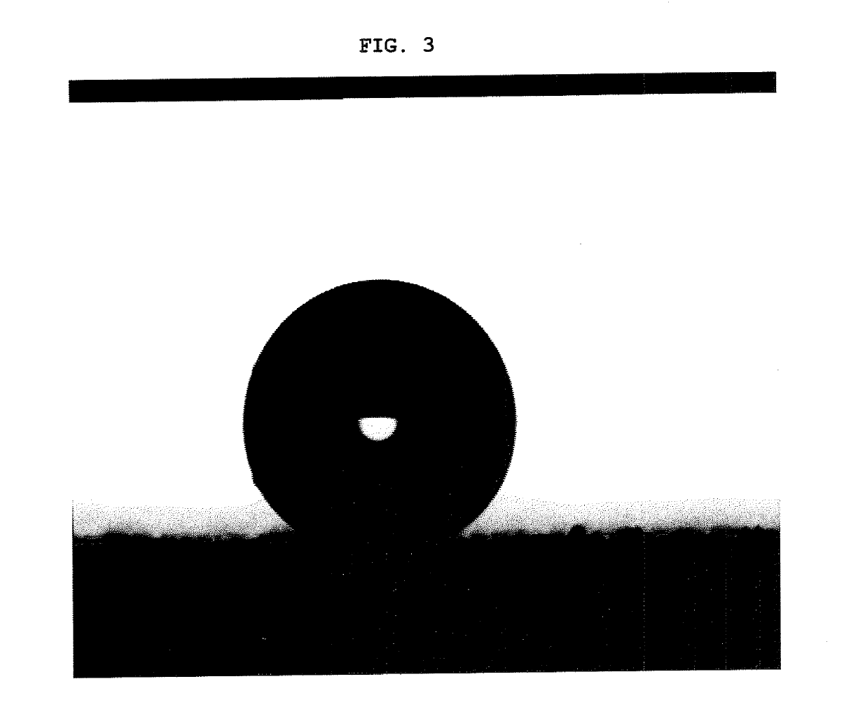

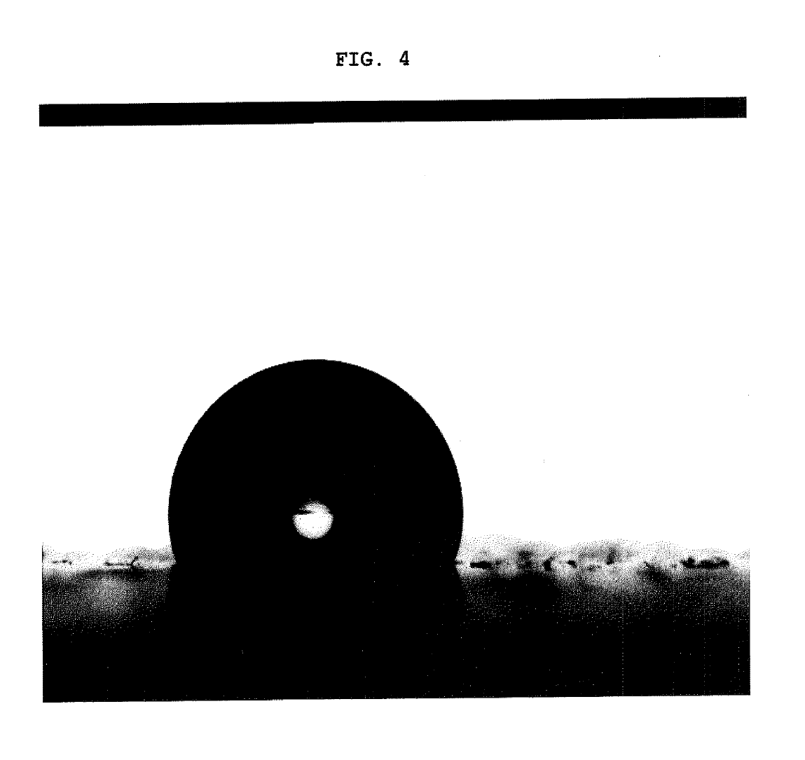

Coating with superhydrophobic properties and an air-water-coating contact angle of greater than 120°, preferably greater than 130°, more preferably greater than 140° C., very preferably greater than 150°. See FIGS. 3 and 4, where FIG. 3 shows the suspension of the invention and FIG. 4 a comparison which differs from the suspension of the invention in that it contains no particles:

Coating with superhydrophobic properties and a water drop roll-off angle of less than 20°, preferably less than 10°, more preferably less than 6°, very preferably less than 3°.

### Example 1

Condensation-crosslinking silicone rubber, amine-eliminating; with hydrophobic silica in a 250 ml plastic beaker, 75 g of a hydrocarbon mixture having a boiling range of 80 to 110° C. are introduced, 15 g of OH-terminated PDMS (polydimethylsiloxane) having a viscosity of about 6000 mPas are added, and the mixture is mixed intensely in a Dispermat at 1500/min for ten minutes at room temperature. Then 4.0 g of a common hydrophobic fumed silica, for example HDK® H18 from Wacker, are added and are incorporated at the same rotary speed within about 10 minutes at room temperature. Subsequently 1.5 g of methyl-tris(cyclohexylamino)silane crosslinker are added, and combining takes place for a further 2 minutes at the same rotary speed at RT.

This dispersion is drawn down using a doctor blade in a wet film thickness of 200 μm and at room temperature the solvent is evaporated for 24 hours and the silicone rubber is subjected to crosslinking under the influence of atmospheric moisture.

The coated surface has a distinctly visible roughness.

Water drop test: water drop jumps away
Drop run-off test: <6°
Contact angle: 142°.

### Example 2

Condensation-crosslinking silicone rubber, amine-eliminating; with hydrophilic silica in a 250 ml plastic beaker, 75.5 g of a hydrocarbon mixture having a boiling range of 80 to 110° C. are introduced, 15 g of OH-terminated PDMS having a viscosity of about 6000 mPas are added, and the mixture is mixed intensely in a Dispermat at 1500/min at room temperature. Then 4.5 g of a hydrophilic fumed silica, for instance the commercially available type Wacker HDK® D05, are added and are incorporated at the same rotary speed within about 10 minutes at room temperature. Subsequently 1.5 g of methyl-tris(cyclohexylamino)silane crosslinker are added, and combining takes place for a further 2 minutes at the same rotary speed at room temperature.

This dispersion is drawn down using a doctor blade in a wet film thickness of 200 μm and at room temperature the solvent is allowed to evaporate for 24 hours and the silicone rubber is subjected to crosslinking under the influence of atmospheric moisture.

The coated surface has a distinctly visible roughness.

Water drop test: water drop jumps away
Drop run-off test: <6°
Contact angle: 143°.

### Example 3

Preparation of a condensation-crosslinking RTV silicone rubber starting system, oxime-based: a 250 ml plastic beaker is charged with 100 g of a hydrocarbon mixture having a boiling range of 80 to 110° C., and 50 g of OH-terminal PDMS polymer having a viscosity of 20 000 mPas are added, and mixing takes place at room temperature in a Dispermat at 300/min over the course of 3 minutes, after which this mixture is admixed with 5.0 g of methyl-tris(methylethylketoximato)silane, and, after a further ten minutes' mixing time at 300/min, 0.25 g of a commercially available tin-based crosslinking catalyst is added, and is incorporated by stirring at identical rotary speed for one minute, and this mixture is then kept in a firmly sealed vessel.

### Example 3a

Condensation-crosslinking RTV silicone rubber system, oxime-based: with hydrophobic silica, 77 g of a hydrocarbon mixture having a boiling range of 80 to 110° C. are introduced into a 250 ml beaker, and 15 g of the silicone rubber mixture described under 3 are added, and mixing takes place at room temperature in a Dispermat at 300/min over the course of 3 minutes. Then 4 g of a commercially available hydrophobized fumed silica, for example HDK® H18 from Wacker, are added in steps within a period of 3 minutes, and are incorporated intensively at room temperature with stirring speeds of 2500/min for 10 minutes.

This dispersion is drawn down using a doctor blade in a wet film thickness of 200 μm and for 24 hours at room temperature the solvent is allowed to evaporate and the silicone rubber is subjected to crosslinking under the influence of atmospheric moisture.

The coated surface is rough!!
Water drop test: water drop jumps away
Drop roll-off angle: <6°
Contact angle: 142°.

### Example 3b

Condensation-crosslinking RTV silicone rubber system, oxime-based: with hydrophilic silica, 81 g of a hydrocarbon mixture having a boiling range of 80 to 110° C. are introduced into a 250 ml plastic beaker, and 15 g of the oxime-crosslinking RTV silicone described under 3 are added, and mixing takes place at room temperature in a Dispermat at 300/min over the course of 3 minutes. Then 4 g of a commercially available hydrophilic fumed silica, such as, for instance, Wacker type HDK° D05, are added in steps within a period of 3 minutes, and are incorporated intensively at room temperature with stirring speeds of 1800/min for 10 minutes.

This dispersion is drawn down using a doctor blade in a wet film thickness of 200 μm and for 24 hours at room temperature the solvent is allowed to evaporate and the silicone rubber is subjected to crosslinking under the influence of atmospheric moisture.

The coated surface is rough.
Water drop test: water drop jumps away
Drop roll-off angle: <6°
Contact angle: 139°.

### Example 4

### Addition-Crosslinking Two-Component Silicone Rubber System

### With Hydrophilic Silica

A 250 ml plastic beaker is charged with 85 g of hydrocarbon mixture having a boiling range of 80-110° C., and the following are added in succession: 6.0 g of vinyl-terminal PDMS polymer having a viscosity of 1000 mPas, 4.5 g of H-terminal PDMS polymer having a viscosity of 1000 mPas, and 0.4 g of a trimethylsilyl-terminal poly-dimethylsiloxy-methyl-hydrogensiloxy copolymer having an Si—H content of 0.17% by weight. The components are mixed at room temperature in a Dispermat at 300/min over the course of 10 minutes. Then 5 g of hydrophilic silica, as described above, are added in steps within a period of 6 minutes, and are incorporated intensely at room temperature with stirring speeds of 5000/min for 5 minutes. Then 0.15 g of tetramethyldivinyldisiloxane and 0.04 g of a common catalyst for addition crosslinking are added and are incorporated by stirring at 5000/min for approximately 5 minutes.

This dispersion is drawn down using a doctor blade in a wet film thickness of 200 μm and the solvent is allowed to evaporate for 24 hours at room temperature, and the silicone rubber is subjected to crosslinking under the influence of atmospheric moisture.

The coated surface is visibly rough.
Water drop test: water drop jumps away
Drop roll-off angle: <6°
Contact angle: 140°.

### Comparative Example 1

Condensation-crosslinking silicone rubber, amine-eliminating; without filler, in a 250 ml plastic beaker, 79 g of hydrocarbon mixture with a boiling range of 80-110° C. are introduced, 15 g of OH-terminated polydimethylsiloxane having a viscosity of about 6000 mPas are added, and intense mixing takes place at room temperature in a Dispermat at 1000/min. Then 1.5 g of methyl-tris(cyclohexylamino)silane crosslinker are added, and combining takes place for a further 2 minutes at the same rotary speed and at room temperature. This dispersion is drawn down using a doctor blade in a wet film thickness of 200 μm and the solvent is evaporated for 24 hours at room temperature, and the silicone rubber is subjected to crosslinking under the influence of atmospheric moisture.

The coated surface has a smooth surface.
Water drop test: remains attached to the surface.
Drop run-off test: 70°
Contact angle: 110°.

### Comparative Example 2

### Condensation-Crosslinking Silicone Rubber, Oxime-Eliminating

### Without Addition of Filler

In a 250 ml plastic beaker, 85 g of hydrocarbon mixture having a boiling range of 80-110° C. are introduced, 15 g of the mixture described under 3, of the silicone rubber which undergoes condensation-crosslinking with oxime elimination, are added, and intense mixing takes place at room temperature in a Dispermat at 300/min over the course of 3 minutes.

This dispersion is drawn down using a doctor blade in a wet film thickness of 200 μm and the solvent is evaporated for 24 hours at room temperature, and the silicone rubber is subjected to crosslinking under the influence of atmospheric moisture.

The coated surface has a smooth surface.
Water drop test: water drop remains on the surface.
Drop run-off test: 50°
Contact angle: 102°.

1. A suspension comprising:
finely divided particles in amounts of 0.01%-50% by weight, the particles having a fractal mass dimension Dₘ of less than or equal to 2.8,
liquid
elastic adhesive in amounts of 101-1000 parts by weight per 100 parts of particles.

2. The suspension as claimed in claim 1, wherein the finely divided particles are hydrophilic particles.

3. The suspension as claimed in claim 1, wherein the finely divided particles are composed of fumed silica.

4. The suspension as claimed in claim 1, wherein the finely divided particles are hydrophilic silicas.

5. The suspension as claimed in claim 1, wherein the finely divided particles have reactive surface groups.

6. The suspension as claimed in claim 1, wherein the elastic adhesive has a reactive oligomer or polymer.

7. The suspension as claimed in claim 1, wherein the elastic adhesive has a crosslinking system.

8. The suspension as claimed in claim 1, wherein the reactive oligomer, polymer, and crosslinking system comprises an RTV1 silicone rubber crosslinking system.

9. The suspension as claimed in claim 8, wherein the RTV1 silicone rubber is an amine-crosslinking silicone rubber system.

10. The suspension as claimed in claim 1, wherein the liquid is an organic solvent.

11. The suspension as claimed in claim 1, wherein the liquid is water.

12. A suspension comprising two or more suspensions according to claim 1.

13. A coating comprising at least one suspension as claimed in claim 1.

14. The coating as claimed in claim 13, wherein the coating has a nanoscale surface roughness.

15. The coating as claimed in claim 13, wherein the coating has an air-water-coating contact angle of greater than 120.

16. The coating as claimed in claim 13, wherein the coating has a water drop roll-off angle of less than 20°.

17. A method for protecting areas in contact with seawater or inland waters, wherein the areas are coated with a suspension as claimed in claim 1.

18. A print medium or surface coating comprising a suspension as claimed in claim 1.
